(19) United States
(12) Patent Application Publication
(10) Pub. No.: US 2020/0124106 A1
(43) Pub. Date: Apr. 23, 2020

(54) DYNAMIC DAMPER DEVICE

(71) Applicant: EXEDY Corporation, Osaka (JP)

(72) Inventor: Yoshihiro MATSUOKA, Osaka (JP)

(73) Assignee: EXEDY Corporation

(21) Appl. No.: 16/549,253

(22) Filed: Aug. 23, 2019

(30) Foreign Application Priority Data
Oct. 17, 2018 (JP) 2018-195674

(51) Int. Cl. F16D 3/12; F16D 3/06; F16F 15/18; F16F 15/14

(52) U.S. Cl. CPC F16D 3/12; F16D 3/06; F16H 45/02; F16F 15/1457; F16F 15/18

(57) ABSTRACT

A dynamic damper device includes first and second rotary members disposed in axial alignment, a third rotary member disposed to be rotatable together with and relative to the first and second rotary members, and a magnetic damper mechanism. The first and second rotary members are coupled to be non-rotatable relative to each other. The magnetic damper mechanism is configured to magnetically couple the first and second rotary members and the third rotary member. The magnetic damper mechanism is configured to generate a resilient force when a relative displacement is produced between the first and second rotary members and the third rotary member in a rotational direction, the resilient force serving to reduce the relative displacement.

### CROSS-REFERENCE TO RELATED APPLICATIONS

This application claims priority to Japanese Patent Application No. 2018-195674, filed Oct. 17, 2018. The contents of that application are incorporated by reference herein in their entirety.

### TECHNICAL FIELD

The present invention relates to a dynamic damper device, particularly to a dynamic damper device inhibiting torque fluctuations in a rotor.

### BACKGROUND ART

For example, a clutch device, including a damper device, and a torque converter are provided between an engine and a transmission in an automobile. Additionally, for reduction in fuel consumption, the torque converter is provided with a lock-up device for mechanically transmitting a torque at a predetermined rotational speed or greater.

In general, the lock-up device includes a clutch part and a damper including a plurality of torsion springs. In the lock-up device described above, torque fluctuations are inhibited by the damper including the plural torsion springs.

Incidentally, a lock-up device described in Japan Laid-open Patent Application Publication No. 2009-293671 is provided with a dynamic damper device including an inertia member so as to inhibit torque fluctuations. The dynamic damper device described in Japan Laid-open Patent Application Publication No. 2009-293671 is provided with coil springs for elastically coupling an output plate and the inertia member in a rotational direction.

As described in Japan Laid-open Patent Application Publication No. 2009-293671, many of the well-known dynamic damper devices have a configuration that the output plate and the inertia member are coupled through the coil springs.

However, in use of the coil springs, a stopper mechanism is required to be provided for preventing the coil springs from being fully compressed in actuation. This results in a drawback that the dynamic damper device is complicated in structure and is also increased in size.

Additionally, there is a drawback that the stopper mechanism is frequently actuated by resonance of the dynamic damper device, whereby hitting sound is produced in actuation of the stopper mechanism.

### BRIEF SUMMARY

It is an object of the present invention to achieve simplification in structure and compactness in size of a dynamic damper device, and in addition, to eliminate production of hitting sound in the dynamic damper device.

(1) A dynamic damper device according to the present invention includes first and second rotary members, a third rotary member and a magnetic damper mechanism. The first and second rotary members are disposed in axial alignment, and are coupled to be non-rotatable relative to each other. The third rotary member is disposed to be rotatable together with and relative to the first and second rotary members. The magnetic damper mechanism magnetically couples the first and second rotary members and the third rotary member. When a relative displacement is produced between the first and second rotary members and the third rotary member in a rotational direction, the magnetic damper mechanism generates a resilient force serving to reduce the relative displacement.

In the present device, the first and second rotary members and the third rotary member are magnetically coupled. In other words, the first and second rotary members and the third rotary member are coupled in the rotational direction by magnetism. Because of this, for instance, when a torque is inputted to the first and second rotary members, the first and second rotary members and the third rotary member are rotated.

Besides, when the torque inputted to the first and second rotary members does not fluctuate, relative displacement is not produced between the first and second rotary members and the third rotary member in the rotational direction. On the other hand, when the torque inputted to the first and second rotary members fluctuates, the relative displacement is produced between the first and second rotary members and the third rotary member in the rotational direction (the displacement will be hereinafter expressed as “rotational phase difference” on an as-needed basis) depending on the extent of torque fluctuations, because the third rotary member is disposed to be rotatable relative to the first and second rotary members.

When the torque does not herein fluctuate, in other words, when the rotational phase difference is not produced between the first and second rotary members and the third rotary member, lines of magnetic force of the magnetic damper mechanism coupling the first and second rotary members and the third rotary member are in a stable condition. On the other hand, when the rotational phase difference is produced between the first and second rotary members and the third rotary member, the lines of magnetic force of the magnetic damper mechanism are distorted, and are in an unstable condition. The lines of magnetic force in the unstable condition are going to restore to the stable condition, whereby the resilient force, by which the rotational phase difference between the first and second rotary members and the third rotary member becomes “0”, acts on the both. In other words, the resilient force, acting on the first and second rotary members and the third rotary member, is similar to an elastic force of an elastic member such as a spring. The elastic force is exerted by the elastic member when the elastic member is elastically deformed, and serves to restore the deformed shape of the elastic member to the original shape thereof. Torque fluctuations are inhibited by this resilient force (elastic force).

The first and second rotary members and the third rotary member are herein magnetically coupled. Hence, it is possible to abolish installation of the coil spring and the stopper mechanism, both of which have been used so far in a well-known device, and to realize simplification in structure and compactness in size of the present device. Besides, by abolishing installation of the stopper mechanism, it is possible to eliminate hitting sound produced so far in actuation of the stopper mechanism in the well-known device.

To increase the resilient force attributed to magnetism, it is herein required to, for instance, increase the size of components (e.g., magnets) of the magnetic damper mechanism. However, in the present invention, the first and second rotary members are disposed in axial opposition to each other, and put differently, the first and second rotary members are provided as divided components of one of two types of rotary members. Hence, the resilient force attributed to magnetism can be increased without increasing the size of components of the magnetic damper mechanism.

(2) Preferably, the magnetic damper mechanism includes a plurality of first magnets provided in the first rotary member, a plurality of second magnets provided in the second rotary member, and a plurality of third magnets provided in the third rotary member. The plurality of third magnets are disposed in opposition to the plurality of first magnets and the plurality of second magnets.

Here, the first and second rotary members and the third rotary member are magnetically coupled by the plural first and second magnets and the plural third magnets opposed to the plural first and second magnets. When the rotational phase difference is produced between the first and second rotary members and the third rotary member by torque fluctuations, the lines of magnetic force between the first and second magnets and the third magnets are turned into the unstable condition from the stable condition. Then, the lines of magnetic force are going to restore to the stable condition, whereby the resilient force (the force by which the rotational phase difference between the first and second rotary members and the third rotary member becomes “0”) acts on the both. Consequently, torque fluctuations are inhibited.

(3) Preferably, the plurality of third magnets are disposed in radial opposition to the plurality of first magnets and the plurality of second magnets. Additionally, the first and second rotary members are axially movable.

In the present invention, each of the first and second rotary members can be herein axially moved with respect to the third rotary member. Because of this, the magnetic damper mechanism can be changed in effective thickness. The resilient force can be changed by changing the effective thickness.

It should be noted that “the effective thickness of the magnetic damper mechanism” refers to the axial length of a region in which the first and second magnets and the third magnets axially overlap as seen in a direction arranged orthogonally to a rotational axis.

(4) Preferably, the first and second rotary members are moved to axially opposite sides.

When the first and second rotary members are axially moved, an axial load is generated in each of the first and second rotary members by magnetism. The axial load acts on a part supporting each of the first and second rotary members, whereby an unintended hysteresis torque is generated.

However, the first and second rotary members, provided as two divided components, are herein moved to the opposite sides. Hence, the axial loads generated in the first and second rotary members are canceled out. Because of this, the hysteresis torques to be generated by the axial loads can be eliminated.

(5) Preferably, the magnetic damper mechanism is equal in effective thickness between a part thereof including the plurality of first magnets and a part thereof including the plurality of second magnets.

Here, the hysteresis torques can be eliminated by moving the first and second rotary members to the axially opposite sides by the same amount. Because of this, it is made easy to control movement of the first and second rotary members so as to eliminate the hysteresis torques.

(6) Preferably, the first rotary member includes a first holder. The first holder includes a first opposed surface having an annular shape, and holds the plurality of first magnets. Additionally, the second rotary member includes a second holder. The second holder includes a second opposed surface having an annular shape, and holds the plurality of second magnets. Moreover, the third rotary member includes a third holder provided as a single component or a plurality of divided components. The third holder includes a third opposed surface opposed to the first and second opposed surfaces, and hold the plurality of third magnets. Furthermore, the third opposed surface is radially opposed to the first and second opposed surfaces at a predetermined gap.

Here, the first, second and third magnets are held by the first, second and third holders of the first, second and third rotary members, respectively. Additionally, the first and second holders and the third holder are radially opposed at the opposed surfaces thereof. Therefore, increase in axial space of the present device can be inhibited.

(7) Preferably, the first and second opposed surfaces and the third opposed surface are shaped such that the predetermined gap is variable with axial movement of the first and second rotary members.

As described above, the resilient force can be changed by changing the effective thickness of the magnetic damper mechanism. Additionally, the resilient force can be changed as well by changing the gap between the opposed magnets.

The gap between the first opposed surface and the third opposed surface and that between the second opposed surface and the third opposed surface are changed by axially moving the first and second rotary members. Because of this, the resilient force can be greatly changed by axially moving the first and second rotary members by a small amount, and the present device can be reduced in axial space.

(8) Preferably, the dynamic damper device further includes a moving mechanism moving the first and second rotary members to the axially opposite sides.

(9) Preferably, the dynamic damper device further includes a drive hub disposed in an inner peripheral part of the first and second rotary members. Additionally, the moving mechanism is provided in an outer peripheral part of the drive hub and the inner peripheral part of the first and second rotary members, and moves the first and second rotary members by a hydraulic pressure.

Here, the moving mechanism can be provided without increasing the size of the present device.

(10) Preferably, the drive hub includes a hub body having an annular shape. Additionally, the moving mechanism includes a first cylinder, a second cylinder, an oil pathway, a first piston and a second piston. The first cylinder is provided in an outer peripheral part of the hub body. The first cylinder axially extends, and is opened to a first axial side. The second cylinder is provided in axial opposition to the first cylinder. The second cylinder axially extends, and is opened to a second axial side. The second cylinder communicates with the first cylinder. The oil pathway supplies a hydraulic oil to either the first cylinder or the second cylinder therethrough. The first piston is provided in the first rotary member, and is inserted into the first cylinder. The second piston is provided in the second rotary member, and is inserted into the second cylinder.

When the hydraulic oil is herein supplied to either the first cylinder or the second cylinder through the oil pathway, the first and second pistons are actuated because the first and second cylinders are communicated with each other. Accordingly, each of the first and second rotary members is axially moved.

(11) Preferably, the moving mechanism further includes an urging member. The urging member urges the first and second pistons in same directions as movement of the first and second rotary members.

Here, the first and second rotary members are axially urged by the urging member. Because of this, the first and second rotary members can be actuated at a low hydraulic pressure.

(12) Preferably, the third rotary member includes a support member having a disc shape. The support member is rotatably supported by the drive hub through a bearing. Additionally, the support member radially extends while being disposed axially between the first and second rotary members.

Here, the support member, composing the third rotary member, is disposed in the gap produced axially between the first and second rotary members provided as two divided components. Because of this, the axial space can be reduced. Additionally, the third rotary member can be supported at the axially intermediate part thereof. In other words, the third rotary member can be stably supported.

(13) Preferably, when the relative displacement is produced between the first and second rotary members and the third rotary member in the rotational direction, the magnetic damper mechanism generates the resilient force serving to reduce the relative displacement by forces of attraction between the plurality of first and second magnets and the plurality of third magnets.

Overall, according to the present invention described above, simplification in structure and compactness in size of the present device can be achieved. Additionally, it is possible to eliminate hitting sound produced so far in actuation of the stopper mechanism in a well-known device. Moreover, in the present invention, one of two types of rotary members is composed of two divided components. Hence, a resilient force attributed to magnetism can be increased without increasing the size of components of the magnetic damper mechanism.

### BRIEF DESCRIPTION OF THE DRAWINGS

FIG. 1 is a cross-sectional configuration view of a dynamic damper device according to a preferred embodiment of the present invention.

FIG. 2 is a partial front view of rotary members, a mass member and a magnetic damper mechanism in the dynamic damper device shown in FIG. 1.

FIG. 3 is a partial enlarged view of FIG. 1.

FIG. 4 is a partial enlarged view of FIG. 1 and shows a part different from the part shown in FIG. 3.

FIG. 5 is a diagram showing a magnetic field when a torsion angle of the magnetic damper mechanism is 0 degrees.

FIG. 6 is a diagram showing a magnetic field when the torsion angle of the magnetic damper mechanism is 10 degrees.

FIG. 7 is a torsional characteristic diagram of the preferred embodiment shown in FIG. 1 and modifications 1 and 2.

FIGS. 8A and 8B are enlarged views of opposed surfaces of the rotary members and the mass member.

FIGS. 9A and 9B are enlarged views of opposed surfaces of the rotary members and the mass member according to a modification.

FIG. 10 is a diagram showing an application example of the dynamic damper device according to the present invention.

FIG. 11 is a diagram showing a magnet layout according to the modification 1 and corresponds to FIG. 2.

FIG. 12 is a diagram showing a magnet layout according to the modification 2 and corresponds to FIG. 2.

FIG. 13 is a diagram showing a magnet layout according to modification 3 and corresponds to FIG. 2.

### DETAILED DESCRIPTION

[Entire Configuration]

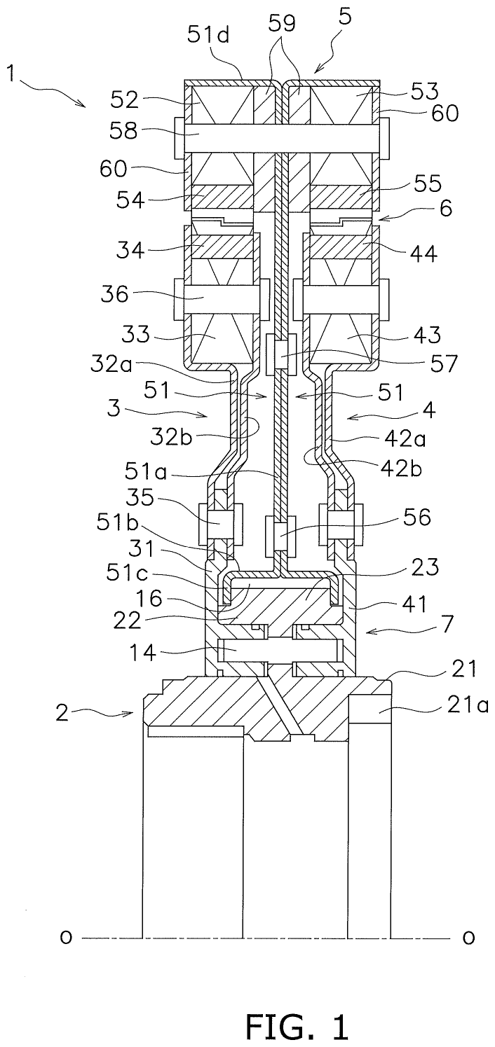

FIG. 1 is a cross-sectional view of a dynamic damper device 1 according to a preferred embodiment of the present invention. In FIG. 1, line O-O indicates a rotational axis. The dynamic damper device 1 includes a drive hub 2, first and second rotary members 3 and 4, a mass member 5 (exemplary third rotary member), a magnetic damper mechanism 6 and a moving mechanism 7.

[Drive Hub 2]

The drive hub 2 is a member that is coupled to, for instance, a lock-up device of a torque converter, and to which a torque is inputted. The drive hub 2 includes a hub body 21 having an annular shape, a cylinder portion 22 provided in the outer peripheral part of the hub body 21, and a support portion 23 having an annular shape. The hub body 21 is provided with an engaging portion 21a on one end of the inner peripheral surface thereof. The support portion 23 is provided on the outer peripheral surface of the cylinder portion 22, and protrudes to the outer peripheral side. A range, in which the support portion 23 is provided, has a shorter axial length than the cylinder portion 22.

[First Rotary Member 3 and Second Rotary Member 4]

The first and second rotary members 3 and 4 (note that these two rotary members, provided as separate components, will be hereinafter simply referred to as “rotary member 3, 4” on an as-needed basis) are coupled to the drive hub 2 by a plurality of drive pins 14. In more detail, the first and second rotary members 3 and 4 are coupled to the drive hub 2 by the drive pins 14, while being axially movable with respect thereto and non-rotatable relative thereto. The first and second rotary members 3 and 4 are shaped to be axially symmetric to each other, and the constituent elements of the both members 3 and 4 are similar to each other. Hence, only the first rotary member 3 will be hereinafter explained.

The first rotary member 3 includes a flange 31, a pair of first support plates 32a and 32b, a first holder 33 and a plurality of first magnets 34.

The flange 31 has a disc shape, and is supported by the drive hub 2 while being axially movable. The pair of first support plates 32a and 32b, each having a substantially disc shape, is fixed at the inner peripheral part thereof to the outer peripheral part of the flange 31 by rivets 35. The pair of first support plates 32a and 32b is made of non-magnetic material such as aluminum. The pair of first support plates 32a and 32b is processed with bending so as to axially separate from each other at the outer peripheral parts thereof.

The first holder 33 is accommodated in the outer peripheral parts of the pair of first support plates 32a and 32b. In other words, the first holder 33 is disposed to be axially interposed by the outer peripheral parts of the pair of first support plates 32a and 32b. The first holder 33 is formed by axially laminating annular plates made of soft magnetic material such as iron. Additionally, rivets 36 are provided to axially penetrate the pair of first support plates 32a and 32b and the first holder 33. The first holder 33 is fixed to the pair of first support plates 32a and 32b by the rivets 36.

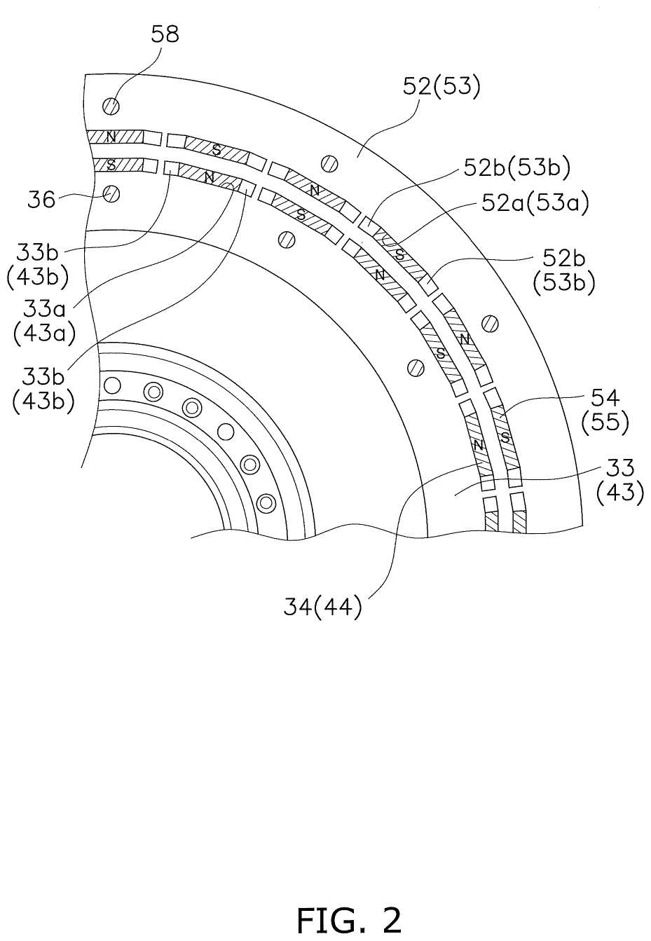

Additionally, as shown in FIG. 2, the first holder 33 is provided with a plurality of accommodation portions 33a and a plurality of flux barriers 33b on the outer peripheral side of the rivets 36. It should be noted that members shown in FIG. 2 are only the first holder 33, a mass body-side holder 52 (to be described) and magnets accommodated therein, while the other members are removed therefrom.

Each accommodation portion 33a is an opening that has a rectangular shape as seen in a front view, and has a predetermined thickness in a radial direction. Additionally, each accommodation portion 33a axially penetrates the first holder 33. Also, the plural accommodation portions 33a are disposed in circular alignment. One pair of flux barriers 33b is provided on the both circumferential ends of each accommodation portion 33a. It should be noted that each accommodation portion 33a and one pair of flux barriers 33b are continuously shaped as a single opening axially penetrating the first holder 33. In other words, one pair of flux barriers 33b is herein one pair of gaps. It should be noted that non-magnetic material such as resin can be attached, as one pair of flux barriers 33b, to each accommodation portion 33a.

As described above, the constituent elements of the first rotary member 3 and those of the second rotary member 4 are similar to each other. In other words, similarly to the first rotary member 3, the second rotary member 4 includes a flange 41, a pair of second support plates 42a and 42b, a second holder 43 and a plurality of second magnets 44. Additionally, the second holder 43 is provided with a plurality of accommodation portions 43a and a plurality of flux barriers 43b.

It should be noted that the first and second holders 33 and 43 will be hereinafter collectively referred to as “inner peripheral side holder 33, 43” on an as-needed basis.

[Mass Member 5]

The mass member 5 is supported by the support portion 23 of the drive hub 2 through a bearing 16, while being rotatable and axially immovable. The drive hub 2 is axially movable and rotatable with respect to the rotary member 3, 4. Consequently, the mass member 5 is axially movable and rotatable relative to the rotary member 3, 4. The mass member 5 includes a pair of third support plates 51 having completely the same shape, third and fourth holders 52 and 53 (note that these bodies 52 and 53 are exemplary divided components of a third holder, and will be hereinafter referred to as “outer peripheral side holder 52, 53” on an as-needed basis), and a plurality of third and fourth magnets 54 and 55 (exemplary third magnets).

As described above, the pair of third support plates 51 has the same shape and is disposed to be axially symmetric to each other. Each third support plate 51 includes a body 51a having a disc shape, an inner peripheral side tubular portion 51b, a stopper portion 51c and an outer peripheral side tubular portion 51d.

In the pair of third support plates 51, the bodies 51a are disposed axially between the first rotary member 3 and the second rotary member 4. The bodies 51a extend to the further outer peripheral side than the first and second rotary members 3 and 4. The bodies 51a are fixed to each other at inner peripheral parts thereof by at least one rivet 56, while being fixed to each other at radially intermediate parts thereof by at least one rivet 57.

In the pair of third support plates 51, the inner peripheral side tubular portions 51b axially extend from the inner peripheral ends of the bodies 51a so as to separate from each other. The bearing 16 is disposed between the inner peripheral side tubular portions 51b and the outer peripheral surface of the support portion 23 of the drive hub 2. The stopper portions 51c are formed by bending the distal ends of the inner peripheral side tubular portions 51b to the inner peripheral side. The stopper portions 51c are shaped to axially interpose the support portion 23 therebetween.

With the aforementioned inner peripheral side tubular portions 51b and stopper portions 51c, the mass member 5 is supported by the drive hub 2, while being axially immovable and rotatable relative thereto.

In the pair of third support plates 51, the outer peripheral side tubular portions 51d axially extend from the outer peripheral ends of the bodies 51a so as to separate from each other. The third and fourth holders 52 and 53 are disposed on the inner peripheral side of the outer peripheral side tubular portions 51d.

Similarly to the first and second holders 33 and 43, the third and fourth holders 52 and 53 are each formed by axially laminating annular plates made of soft magnetic material such as iron. The third and fourth holders 52 and 53 are disposed to make contact with the inner peripheral surface of the outer peripheral side tubular portions 51d. Additionally, the third and fourth holders 52 and 53 are fixed to the pair of third support plates 51 by a plurality of rivets 58 penetrating the third and fourth holders 52 and 53 and the pair of third support plates 51.

Moreover, the third holder 52 is disposed in opposition to and on the outer peripheral side of the first holder 33. Likewise, the fourth holder 53 is disposed in opposition to and on the outer peripheral side of the second holder 43. Furthermore, a first gap, having a predetermined dimension, is produced between the outer peripheral surface (exemplary first opposed surface) of the first holder 33 and the inner peripheral surface (exemplary third opposed surface) of the third holder 52. Likewise, a second gap, having the same dimension as the first gap, is produced between the outer peripheral surface (exemplary second opposed surface) of the second holder 43 and the inner peripheral surface (exemplary third opposed surface) of the fourth holder 53. The respective gaps will be described below.

It should be noted that a spacer 59 is disposed between the body 51a of each third support plate 51 and each of the third and fourth holders 52 and 53. Additionally, a cover plate 60, having an annular shape, is disposed on the axially outer surface of each holder 52, 53. The spacer 59 and the cover plate 60 are made of non-magnetic material such as aluminum, and are fixed together with each holder 52, 53 to the pair of third support plates 51 by the rivets 58.

Moreover, as shown in FIG. 2, each of the third and fourth holders 52 and 53 is provided with a plurality of accommodation portions 52a, 53a and a plurality of flux barriers 52a, 53a on the inner peripheral side of the rivets 58.

Each accommodation portion 52a, 53a is an opening that has a rectangular shape as seen in the front view, and has a predetermined thickness in the radial direction. Additionally, each accommodation portion 52a, 53a axially penetrates each holder 52, 53. Also, the plural accommodation portions 52a, 53a are disposed in circular alignment, while being radially opposed to the accommodation portions 33a, 43a of each holder 33, 43 corresponding to each holder 52, 53. One pair of flux barriers 52b, 53b is provided on the both circumferential ends of each accommodation portion 52a, 53a. One pair of flux barriers 52b, 53b is one pair of openings axially penetrating the holder 52, 53. In other words, one pair of flux barriers 52b, 53b is herein one pair of gaps. It should be noted that non-magnetic material such as resin can be attached, as one pair of flux barriers 52b, 53b, to each accommodation portion 52a, 53a. One pair of flux barriers 52b, 53b is shaped continuously to each accommodation portion 52a, 53a, and each is shaped to slant radially inward with separation from the boundary thereof against each accommodation portion 52a, 53a.

[Magnetic Damper Mechanism 6]

The magnetic damper mechanism 6 is a mechanism that magnetically couples the rotary member 3, 4 and the mass member 5 and generates a resilient force when relative displacement is produced between the rotary member 3, 4 and the mass member 5 in a rotational direction. The resilient force serves to reduce the relative displacement. It should be noted that the expression “magnetically coupling the rotary member 3, 4 and the mass member 5” means coupling the both in the rotational direction by magnetism.

The magnetic damper mechanism 6 is composed of the plural first magnets 34 provided in the first rotary member 3, the plural second magnets 44 provided in the second rotary member 4 (note that these magnets 34 and 44 will be hereinafter referred to as “inner peripheral side magnets 34, 44” on an as-needed basis), the plural third magnets 54 provided in the mass member 5, and the plural fourth magnets 55 provided in the mass member 5 (note that these magnets 54 and 55 will be hereinafter referred to as “outer peripheral side magnets 54, 55” on an as-needed basis).

The plural inner peripheral side magnets 34, 44 are disposed in the accommodation portions 33a, 43a of the rotary member 3, 4. On the other hand, the plural outer peripheral side magnets 54, 55 are disposed in the accommodation portions 52a, 53a of the mass member 5. Therefore, the inner peripheral side magnets 34, 44 and the outer peripheral side magnets 54, 55 are disposed in radial opposition to each other. Moreover, the axial length of each inner peripheral side magnet 34, 44 and that of each outer peripheral side magnet 54, 55 are equal.

The inner peripheral side magnets 34, 34 and the outer peripheral side magnets 54, 55 are permanent magnets formed by neodymium sintered magnets or so forth. As shown in FIG. 2, each opposed pair of the inner peripheral side magnet 34, 44 and the outer peripheral side magnet 54, 55 is disposed to have opposite polarities N and S whereby a pull force (force of attraction) is generated therebetween. Additionally, the plural inner peripheral side magnets 34, 44 are disposed such that the polarities N and S are alternately disposed in circumferential alignment. This configuration is also true of the plural outer peripheral side magnets 54, 55.

[Moving Mechanism 7]

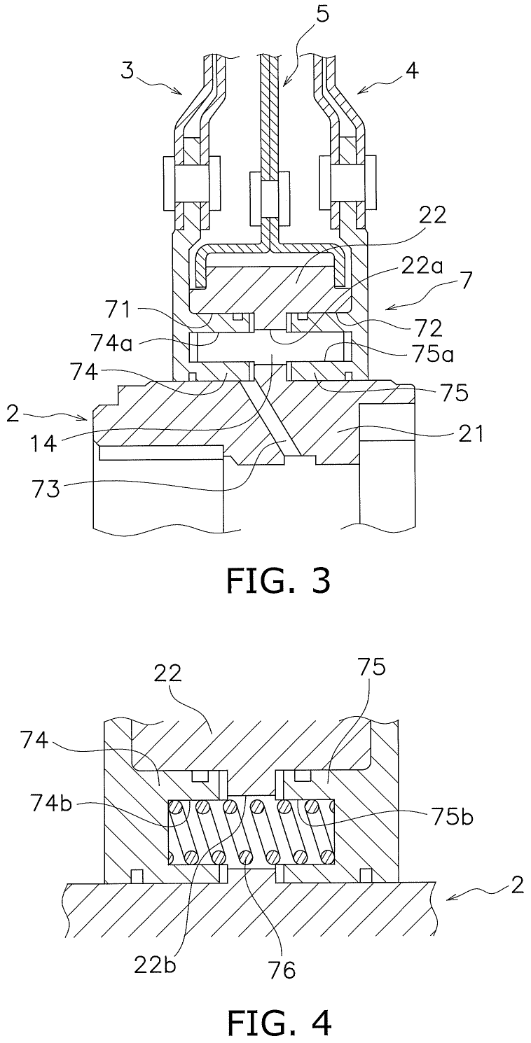

The moving mechanism 7 is provided in the cylinder portion 22 of the drive hub 2 and the inner peripheral parts of the first and second rotary members 3 and 4. The moving mechanism 7 moves the first and second rotary members 3 and 4 to axially opposite sides by hydraulic pressure. As shown close-up in FIGS. 3 and 4, the moving mechanism 7 includes first and second cylinders 71 and 72, an oil pathway 73, first and second pistons 74 and 75, and a plurality of coil springs 76 (exemplary urging member). It should be noted that FIG. 4 is a partial view of a site located in a different circumferential position from a site shown in FIG. 3.

The first cylinder 71 is an annular groove provided in the cylinder portion 22, and axially extends while being opened to a first axial side (left side in FIG. 1). The second cylinder 72 is an annular groove provided in the cylinder portion 22, and is provided in axial opposition to the first cylinder 71. The second cylinder 72 axially extends while being opened to a second axial side (right side in FIG. 1). Additionally, the second cylinder 72 communicates with the first cylinder 71 on the first axial side.

The oil pathway 73 is provided in the hub body 21 of the drive hub 2, while radially penetrating therethrough. In more detail, the oil pathway 73 is provided from the inner peripheral surface of the hub body 21 to the interior of the first cylinder 71 so as to make the both communicate therethrough. Hydraulic oil is supplied to the first cylinder 71 through the oil pathway 73, and is further supplied from the first cylinder 71 to the second cylinder 72.

The first piston 74 is an annular protrusion shaped to axially extend from the inner peripheral part of the first rotary member 3. The first piston 74 is inserted into the first cylinder 71, while being movable therein. The second piston 75 is an annular protrusion shaped to axially extend from the inner peripheral part of the second rotary member 4. The second piston 75 is inserted into the second cylinder 72, while being movable therein. Additionally, each piston 74, 75 is provided with seal members on the inner and outer peripheral surfaces thereof.

Each piston 74, 75 is provided with a plurality of pin holes 74a, 75a and a plurality of spring holes 74b, 75b. The pin holes 74a, 75a and the spring holes 74b, 75b are each shaped to axially extend from the distal end of each piston 74, 75 at a predetermined depth. In other words, the pin holes 74a, 75a and the spring holes 74b, 75b are closed-end holes. On the other hand, the drive hub 2 is provided with a plurality of pin through holes 22a and a plurality of spring through holes 22b in the cylinder portion 22 so as to make the first and second cylinders 71 and 72 communicate therethrough.

The drive pins 14 are provided to penetrate the pin through holes 22a of the cylinder portion 22, respectively. Additionally, each drive pin 14 is inserted at one end thereof into each pin hole 74a of the first piston 74, while being inserted at the other end into each pin hole 75a of the second piston 75. The first and second pistons 74 and 75, i.e., the first and second rotary members 3 and 4 are coupled to each other by the drive pins 14, while being axially movable and non-rotatable relative to each other.

The coil springs 76 are provided to penetrate the spring through holes 22b of the cylinder portion 22, respectively. Additionally, each coil spring 76 is inserted at one end thereof into each spring hole 74b of the first piston 74, while being inserted at the other end thereof into each spring hole 75b of the second piston 75. As shown in FIG. 4, each coil spring 76 is set in a compressed state, while the first and second rotary members 3 and 4 are not being axially moved. In other words, the first and second rotary members 3 and 4 receive, from the coil springs 76, preloads directed to axially separate the both from each other.

[Actuation of Magnetic Damper Mechanism 6]

In the present preferred embodiment, a torque is inputted to the drive hub 2 from a drive source such as an engine (not shown in the drawings).

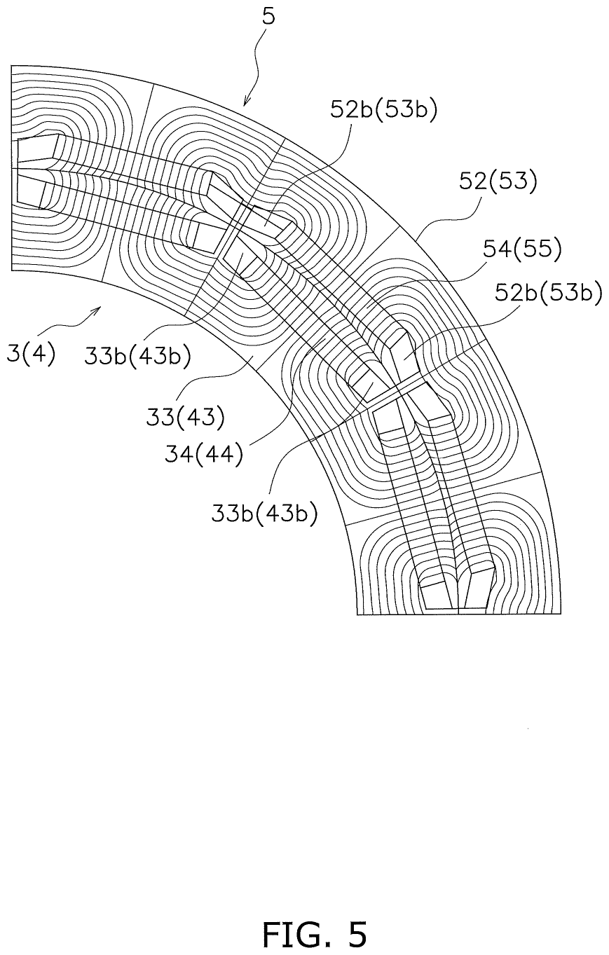

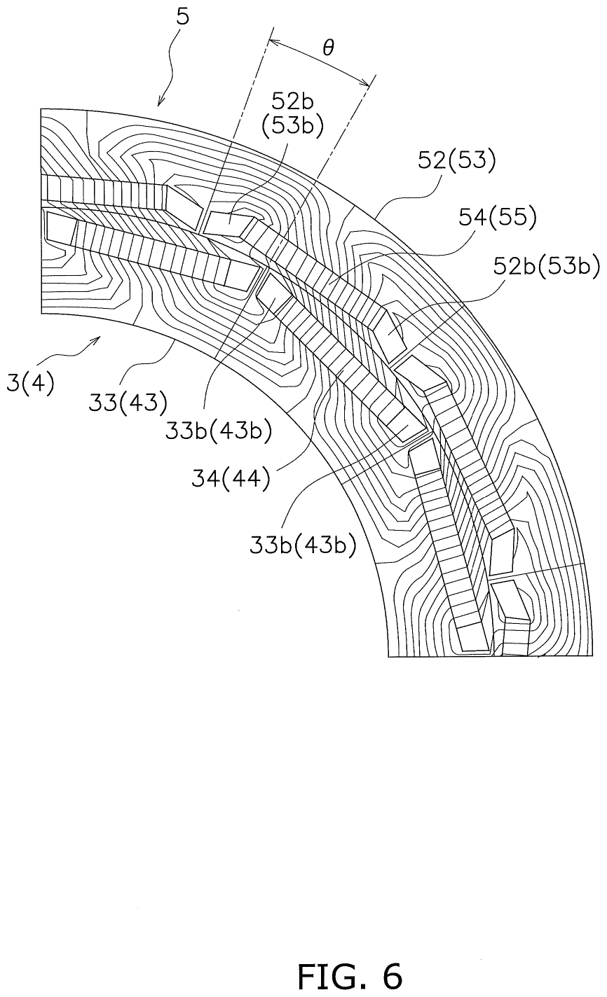

FIGS. 5 and 6 are magnetic field diagrams showing lines of magnetic force between the inner peripheral side magnets 34, 44 and the outer peripheral side magnets 54, 55. It should be noted that in FIGS. 5 and 6, radially extending straight lines are depicted between circumferentially adjacent two of the inner peripheral side magnets 34, 44 and between circumferentially adjacent two of the outer peripheral side magnets 54, 55 for convenience and easy understanding of the rotational phase difference between the inner peripheral side holder 33, 43 and the outer peripheral side holder 52, 53 and a condition of lines of magnetic force. Hence, the radially extending straight lines are not depicted as lines of magnetic force. Additionally, circumferential division of each holder is not indicated by the radially extending straight lines.

When torque fluctuations do not exist in torque transmission, the rotary member 3, 4 and the mass member 5 are rotated in the condition shown in FIG. 5. In other words, the rotary member 3, 4 and the mass member 5 are rotated without relative displacement in the rotational direction (i.e., in a condition that the rotational phase difference is “0”), because the rotary member 3, 4 and the mass member 5 are magnetically coupled by the pull forces (forces of attraction) of the inner peripheral side magnets 34, 44 and the outer peripheral side magnets 54, 55 provided in the respective holders 33, 43 and 52, 53.

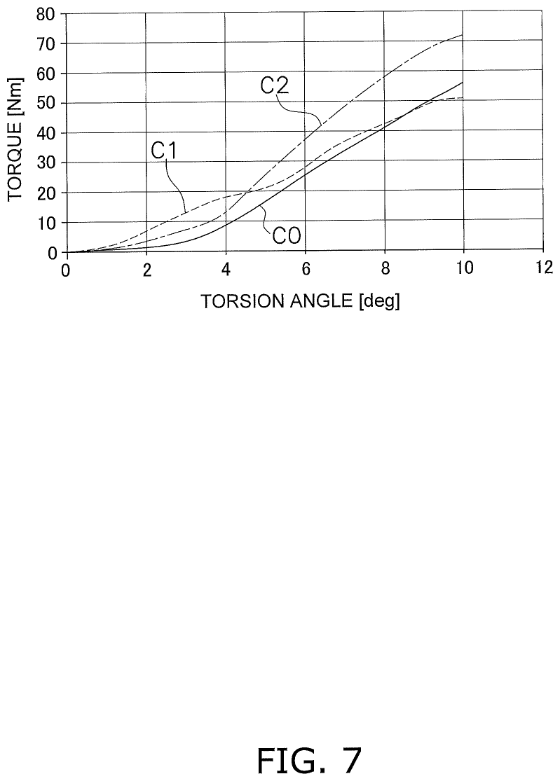

In such a condition that the polarity N of the inner peripheral side magnet 34, 44 and the polarity S of the outer peripheral side magnet 54, 55 are opposed in each pair of inner peripheral side and outer peripheral side magnets 34, 44 and 54, 55 without being displaced in the rotational direction, lines of magnetic force generated by the inner peripheral side magnets 34, 44 and the outer peripheral side magnets 54, 55 are in the most stable condition. This condition corresponds to the origin (where torsion angle is 0 degrees) in the torsional characteristic diagram of FIG. 7.

On the other hand, when torque fluctuations exist in torque transmission, a rotational phase difference θ (of 10 degrees in this example) is produced between the rotary member 3, 4 and the mass member 5 as shown in FIG. 6. In this condition, lines of magnetic force generated by the inner peripheral side magnets 34, 44 and the outer peripheral side magnets 54, 55 are distorted, and are in an unstable condition. The lines of magnetic force in the unstable condition are going to restore to the stable condition as shown in FIG. 5, whereby a resilient force is generated. In other words, the resilient force is generated to make the rotational phase difference between the rotary member 3, 4 and the mass member 5 “0”. The resilient force corresponds to an elastic force in a heretofore known damper mechanism using torsion springs.

As described above, when the rotational phase difference is produced between the rotary member 3, 4 and the mass member 5 by torque fluctuations, the rotary member 3, 4 receives the resilient force that is attributed to the inner peripheral side magnets 34, 44 and the outer peripheral side magnets 54, 55 and is directed to reduce the rotational phase difference between the rotary member 3, 4 and the mass member 5. Torque fluctuations are inhibited by this force.

The aforementioned force for inhibiting torque fluctuations is changed in accordance with the rotational phase difference between the rotary member 3, 4 and the mass member 5, whereby torsional characteristic C0 can be obtained as shown in FIG. 7.

[Actuation of Moving Mechanism 7]

When the hydraulic oil is introduced to the respective cylinders 71 and 72 through the oil pathway 73, the pistons 74 and 75 corresponding thereto are actuated. Accordingly, the first rotary member 3 is moved to the first axial side, whereas the second rotary member 4 is moved to the second axial side. The amount of movement of the first rotary member 3 and that of the second rotary member 4 are the same. In other words, the first rotary member 3 and the second rotary member 4 are moved to the axially opposite sides by the same amount.

When each rotary member 3, 4 is thus axially moved, the magnetic damper mechanism 6 can be reduced in effective thickness (that refers to, as described above, the axial length of a region in which the inner peripheral side magnets 34, 44 and the outer peripheral side magnets 54, 55 axially overlap as seen in a direction arranged orthogonally to the axis). With reduction in effective thickness, it is possible to reduce the magnetic coupling force between the rotary member 3, 4 and the mass member 5, i.e. the elastic force (the resilient force). Therefore, the dynamic damper device can be reduced in torsional stiffness. Specifically, the slope of the characteristic shown in FIG. 7 can be made as gentle as possible.

[Gap between Inner Peripheral Side Holder 33, 43 and Outer Peripheral side Holder 52, 53]

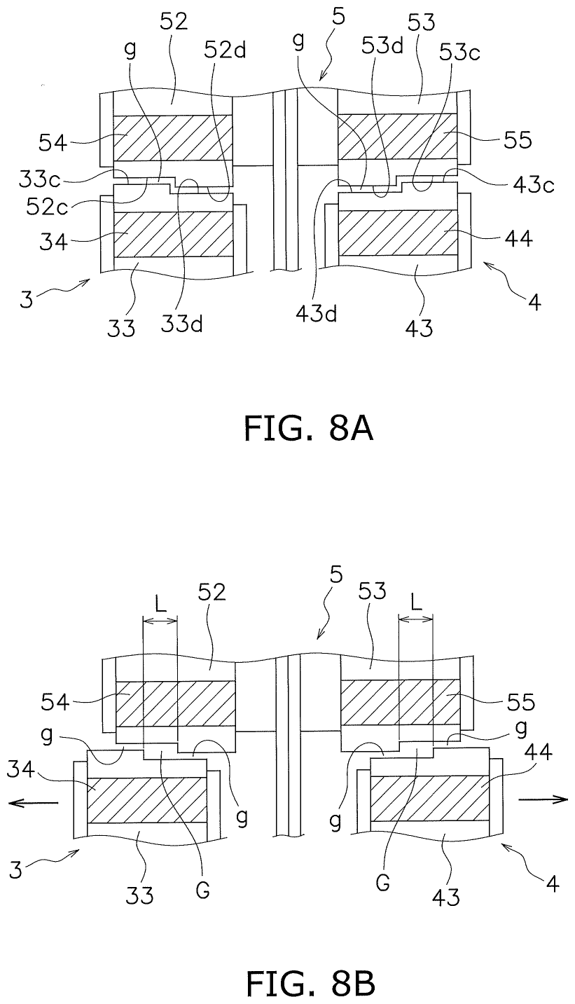

As described above, the outer peripheral surface of the inner peripheral side holder 33, 43 and the inner peripheral surface of the outer peripheral side holder 52, 53 are opposed through a predetermined gap. As shown close-up in FIGS. 8A and 8B, each of the opposed surfaces is made in the form of a stepped surface. In more detail, the outer peripheral surface of the inner peripheral side holder 33, 43 includes a large diameter portion 33c, 43c disposed on the axially outer side and a small diameter portion 33d, 43d disposed on the axially inner side. On the other hand, the inner peripheral surface of the outer peripheral side holder 52, 53 includes a large diameter portion 52c, 53c in a part thereof opposed to the large diameter portion 33c, 43c of the inner peripheral side holder 33, 43, and includes a small diameter portion 52d, 53d in a part thereof opposed to the small diameter portion 33d, 43d of the inner peripheral side holder 33, 43.

In the configuration described above, as shown in FIG. 8A, when the inner peripheral side holder 33, 43 and the outer peripheral side holder 52, 53 are located in the same axial position, the radial gap between the inner peripheral side holder 33, 43 and the outer peripheral side holder 52, 53 is entirely made constant in the axial direction as a gap g.

Here, as shown in FIG. 8B, when the first and second rotary members 3 and 4 are moved to the axially opposite sides by the moving mechanism 7, a gap G, which is wider than the gap g, is produced in an axial range L of the opposed surfaces because of the stepped shapes of the opposed surfaces, whereas the gap g is produced in the remaining region of the opposed surfaces. Besides, the effective thickness of the magnetic damper mechanism 6 is also changed and reduced. Thus, the gap (air gap) between the opposed surfaces and the effective thickness are changed with axial movement of the first and second rotary members 3 and 4, whereby the resilient force can be greatly changed.

When the rotary member 3, 4 is herein axially moved, an axial load acts on the rotary member 3, 4 and the mass member 5. This axial load acts on a part such as a bearing supporting the respective members, whereby an unintended hysteresis torque is generated.

However, in the present preferred embodiment, the first and second rotary members 3 and 4 are moved oppositely to each other by the same distance. Therefore, axial loads to be generated by movement of these rotary members 3 and 4 are canceled out. Because of this, a hysteresis torque to be generated by movement and rotation of the rotary member 3, 4 can be eliminated.

Additionally in the example shown in FIGS. 8A and 8B, each of the inner peripheral side holder 33, 43 and the outer peripheral side holder 52, 53 can be made of two sizes of laminated steel plates composed of one provided as a large diameter portion and the other provided as a small diameter portion.

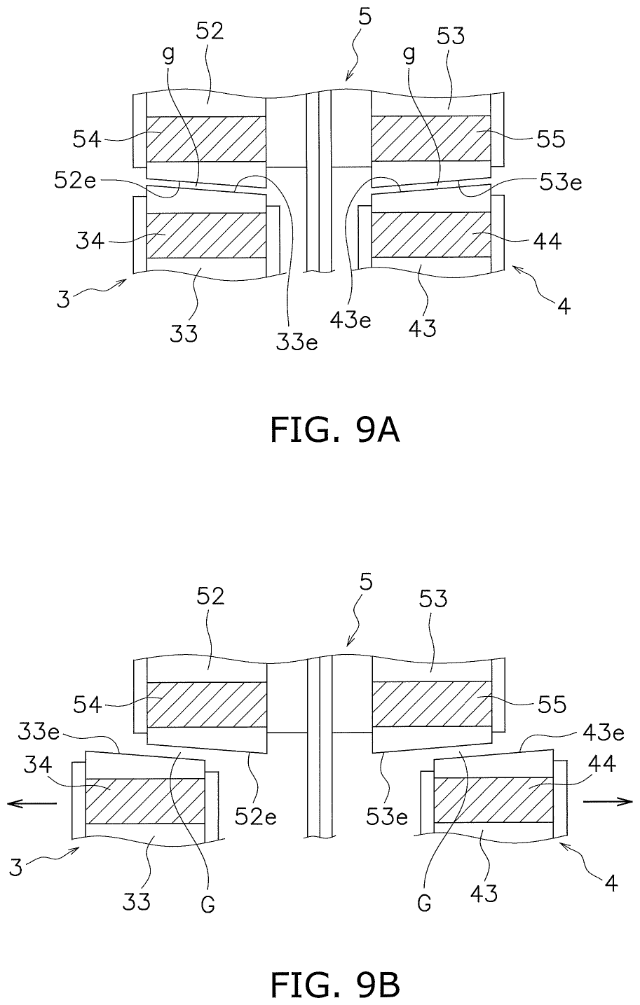

It should be noted that as shown in FIGS. 9A and 9B, even when an outer peripheral surface 33e, 43e of the inner peripheral side holder 33, 43 and an inner peripheral surface 52e, 53e of the outer peripheral side holder 52, 53 are shaped to taper off, it is possible to obtain advantageous effects similar to those achieved as described above. In this example, the outer peripheral surface 33e, 43e of the inner peripheral side holder 33, 43 is shaped to have a diameter gradually reducing from the axially outside to the axially inside. Likewise, the inner peripheral surface 52e, 53e of the outer peripheral side holder 52, 53 is shaped to have a diameter gradually reducing from the axially outside to the axially inside.

In the configuration described above, as shown in FIG. 9A, when the inner peripheral side holder 33, 43 and the outer peripheral side holder 52, 53 are located in the same axial position, the radial gap between the both corresponds to the gap g. On the other hand, as shown in FIG. 9B, when the first and second rotary members 3 and 4 are axially moved by the moving mechanism 7, the gap g is widened and changed into the gap G. Besides, the effective thickness is also changed and reduced. Thus, the air gap and the effective thickness are changed with axial movement of the first and second rotary members 3 and 4, whereby the resilient force can be greatly changed.

[Application Examples]

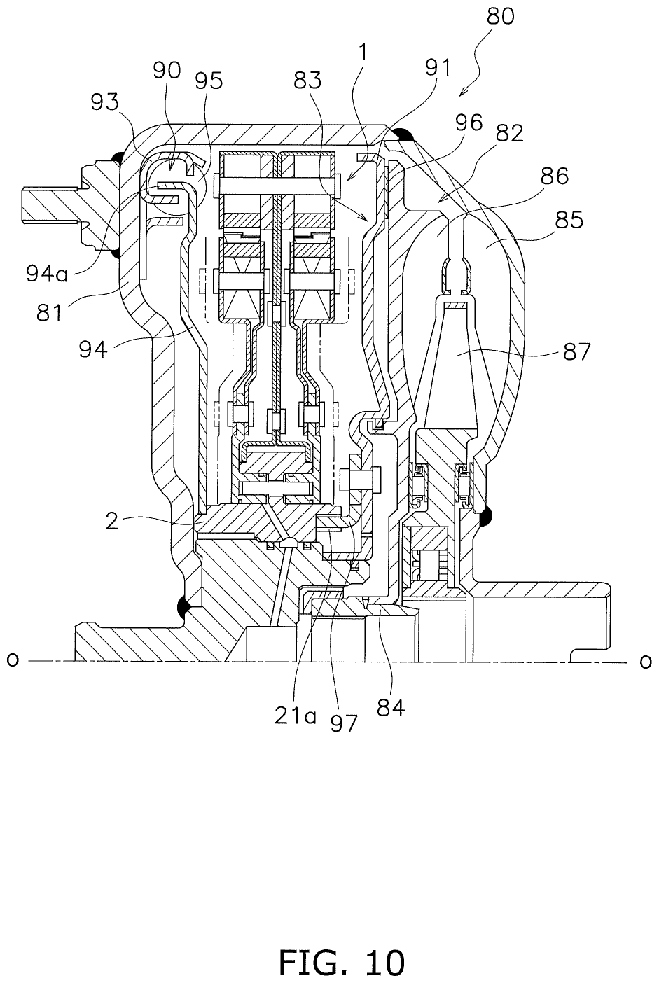

FIG. 10 shows an example that the dynamic damper device 1 according to the aforementioned preferred embodiment is applied to a torque converter 80. The torque converter 80 includes a front cover 81, a torque converter body 82, a lock-up device 83 and an output hub 84.

A torque is inputted to the front cover 81 from the engine. The torque converter body 82 includes an impeller 85 coupled to the front cover 81, a turbine 86 and a stator 87. The turbine 86 is coupled to the output hub 84. An input shaft of a transmission (not shown in the drawings) is capable of being spline-coupled to the inner peripheral part of the output hub 84.

The lock-up device 83 is capable of being set to a lock-up on state and a lock-up off state. In the lock-up on state, the torque inputted to the front cover 81 is transmitted to the output hub 84 through the lock-up device 83 without through the torque converter body 82. On the other hand, in the lock-up off state, the torque inputted to the front cover 81 is transmitted to the output hub 84 through the torque converter body 82. The lock-up device 83 includes a damper part 90 and a piston 91.

The damper part 90 includes an input member 93, a drive plate 94 and a plurality of torsion springs 95.

The input member 93 is fixed to the front cover 81. The drive plate 94 has a disc shape, includes an engaging portion 94a in the outer peripheral part thereof, and is fixed at the inner peripheral end thereof to the outer peripheral surface of the drive hub 2. The torsion springs 95 elastically couple the input member 93 and the drive plate 94 in the rotational direction. The piston 91 is provided with a friction member 96 on the outer peripheral part thereof. The friction member 96 is capable of being pressed onto the outer peripheral surface of the turbine 86. Additionally, an engaging member 97 is fixed to the inner peripheral part of the piston 91. The engaging member 97 is engaged with the engaging portion 21a of the drive hub 2, while being non-rotatable relative thereto and axially movable.

Here in the lock-up on state, after transmitted from the front cover 81, the torque is transmitted from the damper part 90 to the engaging member 97 and the piston 91 through the drive hub 2 of the dynamic damper device 1. Then, the torque is transmitted from the piston 91 to a transmission-side member through the turbine 86 and the output hub 84.

In the actuation described above, fluctuations in torque of the drive hub 2 (i.e., the first and second rotary members 3 and 4) are inhibited by the actuation of the magnetic damper mechanism 6 described above.

[Other Preferred Embodiments]

The present invention is not limited to the preferred embodiment described above, and a variety of changes or modifications can be made without departing from the scope of the present invention.

(a) In the example of FIG. 2, the outer peripheral side magnets are disposed in opposition to the inner peripheral magnets on a one-to-one basis. However, one of each pair of outer peripheral side and inner peripheral side magnets can be divided.

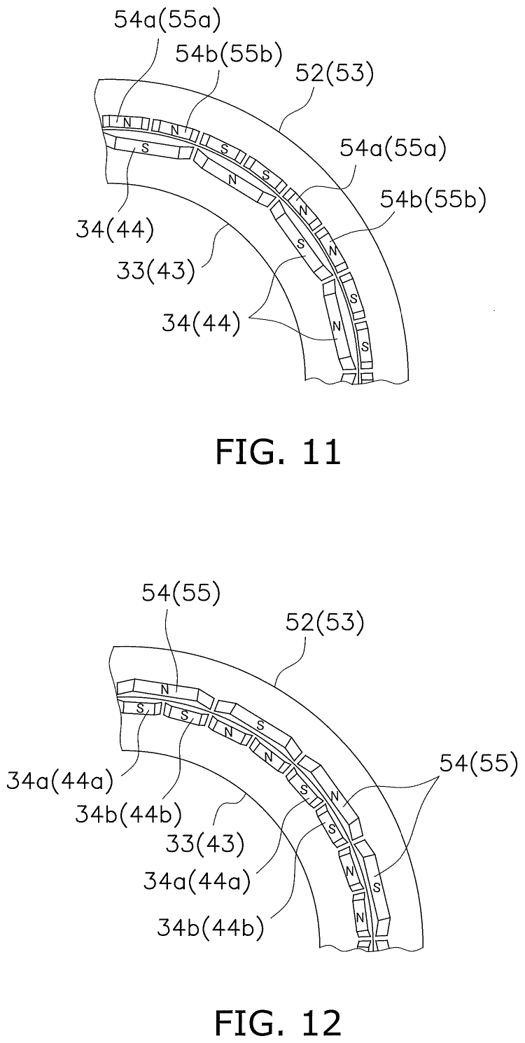

For example, in modification 1 shown in FIG. 11, two outer peripheral side magnets 54a and 54b (55a and 55b) are disposed in opposition to one inner peripheral side magnet 34 (44). On the other hand, in modification 2 shown in FIG. 12, one outer peripheral side magnet 54 (55) is disposed in opposition to two inner peripheral side magnets 34a and 34b (44a and 44b).

According to these examples shown in FIGS. 11 and 12, in the stable condition as shown in FIG. 5, in other words, in the condition without rotational phase difference between the rotary member 3, 4 and the mass member 5, initial distortion is supposed to be caused in lines of magnetic force. A preliminary resilient force (a resilient force generated in the stable condition) is generated by this initial distortion. Therefore, torsional stiffness can be enhanced. For example, as shown in FIG. 7, the value of torque to torsion angle can be enhanced from characteristic C0 to characteristic C1 in a low torsion angular range of 0 to 4 degrees. It should be noted that in the torsional characteristics of modifications 1 and 2, the value of torque is “0” at a torsion angle of 0 degrees. This is because initial distortions (preliminary resilient forces) of the divided magnets are directed oppositely, and are thereby canceled out.

FIG. 7 shows torsional characteristics of the examples shown in FIGS. 2, 11 and 12. Characteristic CO indicates the characteristic of the example shown in FIG. 2; characteristic C1 indicates the characteristic of modification 1 shown in FIG. 11; and characteristic C2 indicates the characteristic of modification 2 shown in FIG. 12.

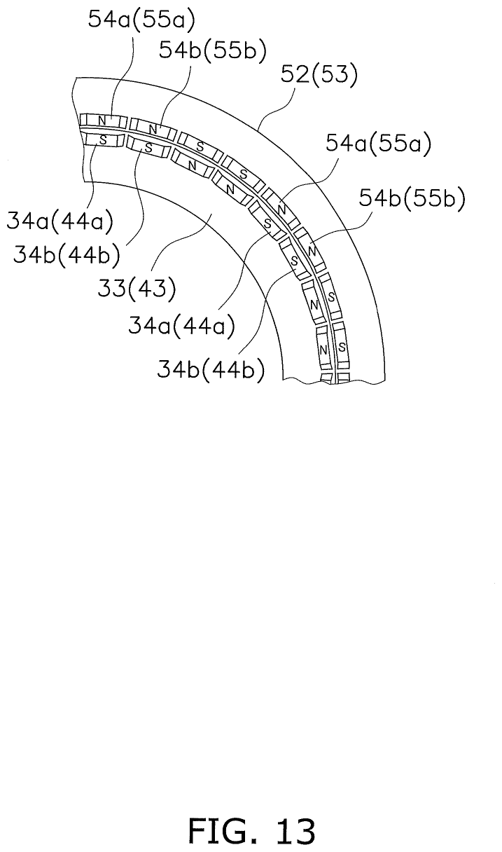

Furthermore, as shown in FIG. 13, each inner peripheral side magnet 34 (44) can be divided, and likewise, each outer peripheral side magnet 54 (55) can be divided. The divided parts of each inner peripheral side magnet 34 (44) can be disposed in opposition to those of each outer peripheral side magnet 54 (55). In short, in the example shown in FIG. 13, two inner peripheral side magnets 34a and 34b (44a and 44b) each having the S polarity are disposed in opposition to two outer peripheral side magnets 54a and 54b (55a and 55b) each having the N polarity. Moreover, in the rotary member 3, 4 and the mass member 5, a plurality of sets of two magnets having the same polarity are circumferentially disposed in alternate alignment of “two magnets having the S polarity→two magnets having the N polarity→two magnets having the S polarity . . . ”.

(b) In the aforementioned preferred embodiment, the mass member 5 is composed of the third holder 52 and the fourth holder 53, but alternatively, can be composed of a single holder. Likewise, the mass member-side magnets are composed of the third magnets 54 and the fourth magnets 55, but alternatively, can be composed of a single type of magnets.

(c) In the aforementioned preferred embodiment, the rotary member, to which a torque is inputted, is divided into the first rotary member 3 and the second rotary member 4. Alternatively, the mass member 5 can be divided into a first mass member and a second mass member, and the first and second mass members can be configured to be axially movable.

(d) In the aforementioned preferred embodiment, the magnets 34, 44, provided in the rotary member 3, 4 to which a torque is inputted, are disposed on the inner peripheral side, whereas the magnets 54, 55, provided in the mass member 5, are disposed on the outer peripheral side. Alternatively, the magnets 34, 44 and the magnets 54, 55 can be switched in position.

(e) In the aforementioned preferred embodiment, the rotary members 3 and 4, provided as two divided components, are configured to be axially moved by the moving mechanism 7. However, the moving mechanism 7 is not an indispensable component.

(f) In the aforementioned preferred embodiment, the moving mechanism 7 is configured to move the two rotary members 3 and 4 to the axially opposite sides by the same amount. However, the configuration of the moving mechanism is not limited to this. For example, the moving mechanism can be configured to move the two rotary members independently from each other in arbitrary directions.

(g) In the modifications shown in FIGS. 11 to 13, either or both of each inner peripheral side magnet and each outer peripheral side magnet are designed to be divided into two parts. However, the number of parts obtained as a result of dividing each inner or outer peripheral side magnet and so forth are not limited to those exemplified in the modifications shown in FIGS. 11 to 13. For example, one of each inner peripheral side magnet and each outer peripheral side magnet can be divided into two (or three) parts, whereas the other can be divided into three (or two) parts.

(h) In the aforementioned preferred embodiment, the opposed surfaces of the inner and outer peripheral side holders have the stepped or tapered shapes. However, in the present invention, the shapes of the opposed surfaces are not limited to the above. The opposed surfaces can be made in the shapes of flat surfaces whereby the gap therebetween is not changed with movement of the rotary member.

### REFERENCE SIGNS LIST

1 Dynamic damper device
2 Drive hub
3 First rotary member
4 Second rotary member
5 Mass member (third rotor)
6 Magnetic damper mechanism
7 Moving mechanism
14 Drive pin
16 Bearing
21 Hub body
33 First holder
34 First magnet
43 Second holder
44 Second magnet
51 Third holding plate
52 Third holder
53 Fourth holder
54 Third magnet
55 Fourth magnet
71 First cylinder
72 Second cylinder
74 First piston
75 Second piston
76 Coil spring (urging member)

What is claimed is:

1. A dynamic damper device comprising:
first and second rotary members disposed in axial alignment, the first and second rotary members coupled to be non-rotatable relative to each other;
a third rotary member disposed to be rotatable together with and relative to the first and second rotary members; and
a magnetic damper mechanism configured to magnetically couple the first and second rotary members and the third rotary member, the magnetic damper mechanism configured to generate a resilient force when a relative displacement is produced between the first and second rotary members and the third rotary member in a rotational direction, the resilient force serving to reduce the relative displacement.

2. The dynamic damper device according to claim 1, wherein the magnetic damper mechanism includes
a plurality of first magnets provided in the first rotary member,
a plurality of second magnets provided in the second rotary member, and
a plurality of third magnets provided in the third rotary member, the plurality of third magnets disposed in opposition to the plurality of first magnets and the plurality of second magnets.

3. The dynamic damper device according to claim 2, wherein
the plurality of third magnets are disposed in radial opposition to the plurality of first magnets and the plurality of second magnets, and
the first and second rotary members are axially movable.

4. The dynamic damper device according to claim 3, wherein the first and second rotary members are moved to axially opposite sides.

5. The dynamic damper device according to claim 4, wherein the magnetic damper mechanism is equal in effective thickness between a part thereof including the plurality of first magnets and a part thereof including the plurality of second magnets.

6. The dynamic damper device according to claim 3, wherein
the first rotary member includes a first holder, the first holder including a first opposed surface having an annular shape, the first holder holding the plurality of first magnets,
the second rotary member includes a second holder, the second holder including a second opposed surface having an annular shape, the second holder holding the plurality of second magnets,
the third rotary member includes a third holder, the third holder provided as a single component or a plurality of divided components, the third holder including a third opposed surface opposed to the first and second opposed surfaces, the third holder holding the plurality of third magnets, and
the third opposed surface is radially opposed to the first and second opposed surfaces at a predetermined gap.

7. The dynamic damper device according to claim 6, wherein the first and second opposed surfaces and the third opposed surface are shaped such that the predetermined gap is variable with axial movement of the first and second rotary members.

8. The dynamic damper device according to claim 3, further comprising:
a moving mechanism configured to move the first and second rotary members to the axially opposite sides.

9. The dynamic damper device according to claim 8, further comprising:
a drive hub disposed in an inner peripheral part of the first and second rotary members, wherein
the moving mechanism is provided in an outer peripheral part of the drive hub and the inner peripheral part of the first and second rotary members, the moving mechanism configured to move the first and second rotary members by a hydraulic pressure.

10. The dynamic damper device according to claim 9, wherein
the drive hub includes a hub body having an annular shape, and
the moving mechanism includes
a first cylinder provided in an outer peripheral part of the hub body, the first cylinder axially extending, the first cylinder opened to a first axial side,
a second cylinder provided in axial opposition to the first cylinder, the second cylinder axially extending, the second cylinder opened to a second axial side, the second cylinder communicating with the first cylinder,
an oil pathway supplying a hydraulic oil to either the first cylinder or the second cylinder therethrough,
a first piston provided in the first rotary member, the first piston inserted into the first cylinder, and
a second piston provided in the second rotary member, the second piston inserted into the second cylinder.

11. The dynamic damper device according to claim 10, wherein the moving mechanism further includes an urging member, the urging member configured to urge the first and second pistons in same directions as movement of the first and second rotary members.

12. The dynamic damper device according to claim 9, wherein
the third rotary member includes a support member having a disc shape, the support member rotatably supported by the drive hub through a bearing, and
the support member radially extends while being disposed axially between the first and second rotary members.

13. The dynamic damper device according to claim 2, wherein the magnetic damper mechanism configured to generate the resilient force by forces of attraction between the plurality of first and second magnets and the plurality of third magnets when the relative displacement is produced between the first and second rotary members and the third rotary member in the rotational direction, the resilient force serving to reduce the relative displacement.
